(19) United States
(12) Patent Application Publication
(10) Pub. No.: US 2016/0034942 A1
(43) Pub. Date: Feb. 4, 2016

(54) One and Only Card

(71) Applicant: Jacquelee J. Graham, Newville, PA (US)

(72) Inventor: Jacquelee J. Graham, Newville, PA (US)

(21) Appl. No.: 14/806,575

(22) Filed: Jul. 22, 2015

Related U.S. Application Data
(60) Provisional application No. 62/027,524, filed on Jul. 22, 2014.

(51) Int. Cl. G06Q 30/02; H04L 29/06

(52) U.S. Cl. CPC G06Q 30/0229; H04L 63/02

(57) ABSTRACT

A single universal consumer identity and savings card program that replaces multiple separate card programs provided by chain retailers.

### CLAIM OF PRIORITY

This patent application claims priority under 35 USC 119 (e) (1) from U.S. Provisional Patent Application Ser. No. 62/027,524 filed Jul. 22, 2014, of common inventorship herewith entitled, “The One and Only Card,” which is incorporated herein by reference as though the same were set forth in its entirety.

### FIELD OF THE INVENTION

The present invention pertains to the field of customer service, and more specifically to the field of retail membership and rewards cards.

### BACKGROUND OF THE INVENTION

The prior art has put forth several designs for retail membership and rewards cards. Among these are:

US Patent Publication 2013/0054261 to Robert Joseph Dufour describes a system to aggregate benefits offered by multiple entities and process prescriptions for these benefits involving, a service provider, one or more prescription benefit management companies or insurers, individual consumers and participating pharmacies. The service provider aggregates incentives available in the marketplace and specific incentives unique for individual programs. Individual consumers receive the benefits of these incentives when a pharmacy transmits a claim request through their pharmacy computer system to the service provider's database and that request is authorized.

US Patent Publication 2013/0015250 to Michael Kaperst describes a unitary membership card comprising a substrate and a bar code means for storing an identifier corresponding to a plurality of membership data items, each of said plurality of membership data items corresponding to an independent membership account associated with a user.

US Patent Publication 2012/0323660 to Richard Postrel describes a system and method for operating a reward points accumulation and redemption program wherein a user earns reward points from a plurality of independent reward points issuing entities. Each entity tracks a user's earned reward points in a user reward point account stored on a multi function card such as a frequent flyer account or a credit card loyalty account. The multi function card is adapted to aggregate some or all of the user's earned reward points from the reward accounts and credit the aggregated points into a single reward exchange account on the multi function card. The user may select an item for purchase with accumulated reward points from the multi function card. The item is provided to the user in exchange for a subset or all of the reward points from the multi function card.

None of these prior art references describe the present invention.

### SUMMARY OF THE INVENTION

It is an object of the present invention to provide a single universal consumer identity and savings card program that replaces multiple separate card programs provided by chain retailers.

### BRIEF DESCRIPTION OF THE DRAWINGS

FIG. 1 are prototypical diagonal back and front views showing a magnetic strip on the back side and a prominent logo imprinted on the front side.

FIG. 2 is an illustrative front view showing how a multiple group of customer loyalty cards are consolidated to the present invention of one card.

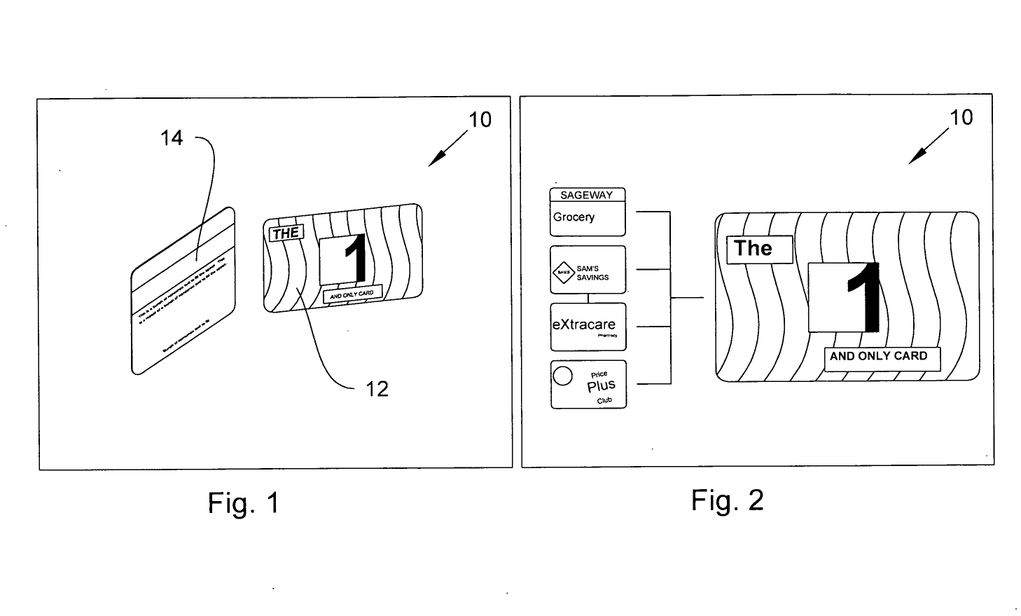

### DETAILED DESCRIPTION OF THE INVENTION

Inventions are always a product of vision and creativity whether they are world changing inventions like cars and computers or everyday conveniences like pump hairsprays, cordless tools and resealable soda bottles. New inventions like a cell phone change a person's life style, making communication more convenient and accessible virtually anywhere. Other inventions such as a snow scraper and brush combine two already existing inventions into an improved embodiment, reducing clutter in our lives and making a daily winter chores much easier. Often necessity combined with a little creativity is the underlying motivator for an invention. Most inventions fill a relatively small need or perform a specialized limited function. If that need is shared by a sufficient number of consumers, an invention has a great potential for success.

Virtually every retail chain of sufficient size, including grocery stores, pharmacies, bookstores and discount stores, operates its own free customer identity and savings card system. The customer signs up and receives a credit card or key chain sized care containing a unique number and barcode identifier for instant scanning at a payment register. The consumer presents this card when paying for their purchases to receive immediate savings from that retailer. The card often entitles the customer to special discount savings offered through email promotions. The customer appreciates discounts and lower prices. The retailer solidifies its relationship with the customer and gains the customer's loyalty. The retailer also gathers statistical information about its customers' buying habits and preferences. The retailer uses this data to refine its inventory in directions that appeal most strongly to its customers.

As currently constructed, this benefit or rewards card system requires that each consumer possess a unique card for each retailer. This requirement results in the consuming carrying around a lot of cards and sorting through them at the register. The current system is inconvenient for consumers and expensive for the retailers who set up and maintain their own logistical system. The present invention, hereinafter referred to as The One and Only Card or The Only Card, consolidates multiple and separate consumer identity and savings card programs into one universal system, providing convenience for consumers and less expense for the retailers. The Only Card is a single universal consumer identity and savings card system that replaces multiple separate card programs provided by chain retailers.

The present invention streamlines the consumer identity and savings card program into a single, comprehensive system. The One and Only Card system 10 provides a consumer with one customer loyalty card 12 that represents all their customer loyalty cards combined. The Only Card consolidates separate customer loyalty programs into one customer loyalty system, eliminating redundancy and reducing expenses for participating retailers while still providing them with useful demographics and spending information about their customers.

The One and Only Card is encrypted in its magnetic strip 14 so that when a customer is making a purchase at one member retailer such as a pharmacy or grocery chain, the scanning apparatus at that chain reads the customer's identifying barcode and enter their purchasing data only into that chain's database. The Only Card is universal from the consumer's point of view, but its collected data is separated and stored in separate databases for each participating retail chain. Employing firewall encryption security, each participating retailer has access only to their chain's collected data. Participating retailers are unable to view or share customer data with other participating retailers. With such safeguards built into the coding and encryption mechanisms of the One and Only Card system, the present invention provides greater convenience to consumers and lower maintenance costs to retailers.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A single universal consumer identity and savings card program that replaces multiple separate card programs provided by chain retailers, comprising:
a consumer customer loyalty card that represents all their customer loyalty cards combined into one card, wherein the card is encrypted in its magnetic strip so that when a customer is making a purchase at one member retailer such as a pharmacy or grocery chain, the scanning apparatus at that chain reads the customer's identifying barcode and enter their purchasing data only into that chain's database.

2. The single universal consumer identity and savings card program of claim 1, further comprising firewall encryption security, wherein each participating retailer has access only to their chain's collected data, and retailers are unable to view or share customer data with other participating retailers.
